(19) United States
(12) Patent Application Publication
(10) Pub. No.: US 2025/0124239 A1
(43) Pub. Date: Apr. 17, 2025

(54) METHOD FOR PROVIDING CONVERSATION AND SYSTEM FOR PROCESSING THE CONVERSATION

(71) Applicant: NAVER CORPORATION, Seongnam-si (KR)

(72) Inventors: Hye Ri KIM, Seongnam-si (KR); Yu In JEONG, Seongnam-si (KR); Dong Hyun KWAK, Seongnam-si (KR); Sang Hwan BAE, Seongnam-si (KR); So Young KANG, Seongnam-si (KR); Jun Ho AN, Seongnam-si (KR); Hyun Hoon JUNG, Seongnam-si (KR); Joo Won YOO, Seongnam-si (KR); Min Young LEE, Seongnam-si (KR); Hyun Jung PARK, Seongnam-si (KR)

(21) Appl. No.: 18/990,462

(22) Filed: Dec. 20, 2024

Related U.S. Application Data
(63) Continuation of application No. PCT/KR2023/008640, filed on Jun. 21, 2023.

(30) Foreign Application Priority Data
Jun. 21, 2022 (KR) 10-2022-0075459
Sep. 16, 2022 (KR) 10-2022-0117106
Sep. 20, 2022 (KR) 10-2022-0118408

(51) Int. Cl. G06F 40/40

(52) U.S. Cl. CPC G06F 40/40

(57) ABSTRACT

A conversation provision method includes forming a conversation session between an agent and a user; generating an utterance of the agent by using the user's history related to a previous conversation session having been formed before the conversation session; and performing a conversation with the user by providing the utterance of the agent to the user.

### CROSS-REFERENCE TO RELATED APPLICATIONS

This is a continuation application of International Application No. PCT/KR2023/008640, filed Jun. 21, 2023, which claims the benefit of Korean Patent Application Nos. 10-2022-0075459, filed Jun. 21, 2022; 10-2022-0117106, filed Sep. 16, 2022; and 10-2022-0118408, filed Sep. 20, 2022.

### BACKGROUND OF THE INVENTION

### Field of the Invention

The present invention relates to a conversation provision method, a conversation processing method, and a system for performing a conversation on the basis of a user's information.

### Description of Related Art

A dictionary definition of artificial intelligence can be described as technology that implements human abilities such as learning, reasoning, perception, and natural language understanding through computer programs. Artificial intelligence has made remarkable advancements due to deep learning.

Particularly, fueled by the advancement of artificial intelligence, various language models have been developed. These language models not only recognize text and understand the meaning of text but also extract and classify information from large datasets containing extensive text, such as documents, and have even reached the level of directly generating text.

These language models are being actively utilized across various fields. For example, there are various fields where tasks can be performed on the basis of text, such as search services, document creation (e.g., resume writing, report writing, post creation, etc.), free conversation across diverse categories, data parsing from given text (e.g., data summarization, classification, etc.), providing specialized knowledge, programming, and converting given sentences into appropriate stylistic forms.

Recently, by using agents (i.e., intelligent agents or artificial intelligence (AI) agents) that provide conversation functions, services are actively being provided to users in various fields such as shopping, search, healthcare, and customer service. However, in the case of using such an agent, there is a limitation in that the agent only considers the conversation content with the user in the current conversation session, and does not take into account the past conversation content between the agent and the user. Accordingly, the user needs to take active actions, such as repeatedly providing personal information in each different conversation session with the agent or correcting the content of the utterance of the agent that does not consider the user's situation, which causes inconvenience for the user.

### BRIEF SUMMARY OF THE INVENTION

The present invention is directed to providing a conversation provision method and a conversation processing system that reflect a user's information to enable an appropriate conversation to be performed between the user and an agent.

Specifically, the present invention is directed to providing a conversation provision method and a conversation processing system that use a user's history information to enable an agent to lead a conversation appropriate to the user's state or situation.

Further, the present invention is directed to providing a conversation provision method and a conversation processing system that is capable of remembering important information about the user and perform a conversation with the user using the remembered important information.

Further, the present invention is directed to providing a conversation analysis method and a system that is capable of systematically managing the user's state by using past conversation content performed between the user and the agent, and a user monitoring method and system using the same.

To achieve the aforementioned objects, there is provided a conversation provision method, according to the present invention. The conversation provision method may include forming a conversation session between an agent and a user, generating an utterance of the agent by using the user's history related to a previous conversation session having been formed before the current conversation session, and performing a conversation with the user by providing the utterance of the agent to the user.

Further, there is provided a conversation processing system, according to the present invention. The conversation processing system may include a memory configured to store a user's history related to a past conversation session, a summarizer configured to receive an utterance of the user in a current conversation session formed between an agent and a user, and to summarize at least part of the utterance of the user in the form of a sentence, and a memory operator configured to specify an operation for the memory using summary information summarized by the summarizer and the user's history.

Further, there is provided a program, stored on a computer-readable recording medium, executed by one or more processes in an electronic device. The program may include instructions for forming a conversation session between an agent and a user, generating an utterance of the agent using a user's history related to a previous conversation session having been formed prior to the conversation session and stored in association with the user's account, and performing a conversation with the user by providing the utterance of the agent to the user.

As described above, the conversation provision method and the conversation processing system according to the present invention can provide a user-customized conversation by performing a conversation with the user using the user's history stored in the memory.

More specifically, the conversation provision method and the conversation processing system according to the present invention, store the utterance of the user from a previous conversation session as the user's history and use the utterance of the user to perform a conversation with the user, enabling a natural conversation with the user on the basis of the most up-to-date information according to the user's history.

Further, in the present invention, by performing a conversation with the user on the basis of the user's history, it is possible to monitor or check the user's situation or state according to the user's history.

The conversation provision method and the conversation processing system according to the present invention can summarize the utterance of the user using a summarizer trained to summarize only important user utterances among the utterances of the user from the conversation session between the user and the agent. Therefore, unnecessary consumption of memory resources can be prevented, and a new conversation session with the user can be provided based on important information related to the user.

### BRIEF DESCRIPTION OF THE DRAWINGS

FIG. 1 is a block diagram of a conversation processing system according to the present invention.

FIGS. 2A-2C and FIG. 3 are diagrams for describing a conversation processing method and a conversation processing system according to the present invention.

FIG. 4 is a diagram for describing a method of processing a conversation in a summarizer of the conversation processing system according to the present invention.

FIGS. 5 to 9 are diagrams for describing a method of processing a conversation in a memory operator of the conversation processing system according to the present invention.

FIG. 10 is a flowchart describing a method of generating a conversation in a generator of the conversation processing system according to the present invention.

FIG. 11 is a diagram for describing a method of generating a conversation in a generator of the conversation processing system according to the present invention.

FIG. 12 is a block diagram of a user monitoring system according to the present invention.

### DETAILED DESCRIPTION OF THE INVENTION

Reference will now be made in detail to embodiments, examples of which are illustrated in the accompanying drawings. In this regard, the present embodiments may have different forms and should not be construed as being limited to the descriptions set.

Hereinafter, exemplary embodiments disclosed in the present specification will be described in detail with reference to the accompanying drawings. The same or similar constituent elements are assigned with the same reference numerals regardless of reference numerals, and the repetitive description thereof will be omitted. The terms “module,” “unit,” and “portion” used to describe constituent elements in the following description are used together or interchangeably in order to facilitate the description, but the terms themselves do not have distinguishable meanings or functions. In addition, in the description of the exemplary embodiment disclosed in the present specification, the specific descriptions of publicly known related technologies will be omitted when it is determined that the specific descriptions may obscure the subject matter of the exemplary embodiment disclosed in the present specification. In addition, it should be interpreted that the accompanying drawings are provided only to allow those skilled in the art to easily understand the embodiments disclosed in the present specification, and the technical spirit disclosed in the present specification is not limited by the accompanying drawings, and includes all alterations, equivalents, and alternatives that are included in the spirit and the technical scope of the present invention.

The terms including ordinal numbers such as “first,” “second,” and the like may be used to describe various constituent elements, but the constituent elements are not limited by the terms. These terms are used only to distinguish one constituent element from another constituent element.

When one constituent element is described as being “coupled” or “connected” to another constituent element, it should be understood that one constituent element can be coupled or connected directly to another constituent element, and an intervening constituent element can also be present between the constituent elements. When one constituent element is described as being “coupled directly to” or “connected directly to” another constituent element, it should be understood that no intervening constituent element is present between the constituent elements.

Singular expressions include plural expressions unless clearly described as different meanings in the context.

The present invention is directed to providing a conversation provision method and a conversation processing system that reflect a user's information to enable an appropriate conversation to be performed between the user and an intelligent agent or artificial intelligence (AI) agent (hereinafter “agent”). Specifically the present invention is directed to providing a conversation provision method and a conversation processing system that use a user's history information to enable an agent to lead a conversation appropriate to the user's state (e.g., mental health, medical or physical condition of the user, etc.) or situation (e.g., financial, employment, housing, etc.).

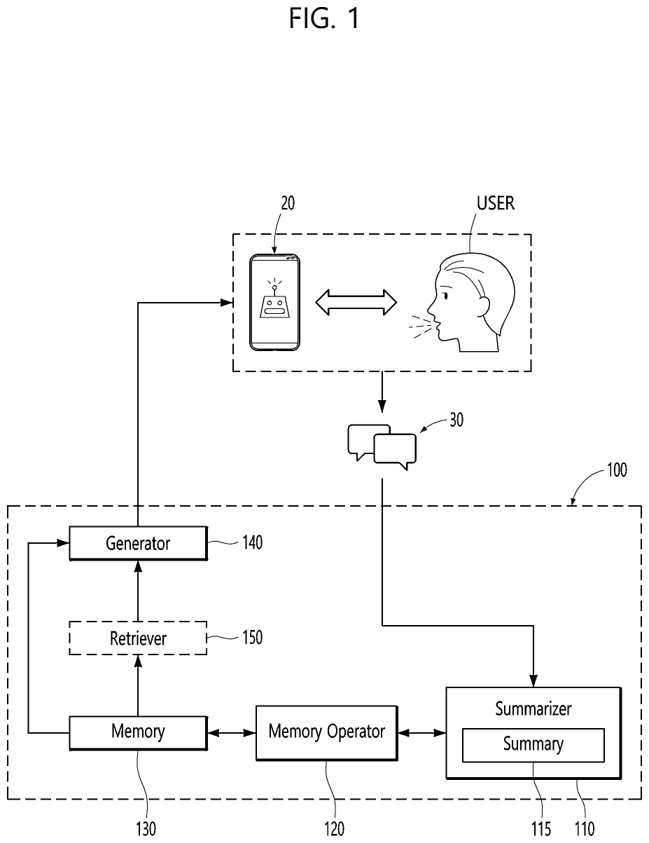

As illustrated in FIG. 1, an agent may be included as one function of various types of electronic devices 2, or may be included as one function of websites, applications, or software that provide various services where a conversation between a user and the agent may take place, such as conversation services, care services, or counseling services. Examples of electronic devices 20 include, but are not limited to, smartphones, tablets, laptops, desktop computers, smart speakers, wearable devices (e.g., smartwatches), and smart home devices (e.g., smart TVs or smart thermostats).

The format of a conversation 30 between the user and the agent may vary, and, for example, the conversation may take place in the form of speech or chat. For the convenience of description, the format of the conversation will not be distinguished between speech or text (e.g., chat). Further, regardless of the format of the conversation, the conversation generated from the user will be referred to as a user utterance or an utterance of the user, and the conversation generated from the agent will be referred to as an agent utterance or an utterance of the agent. An agent performing a conversation with the user may also be referred to as a “bot” or “chatbot.”

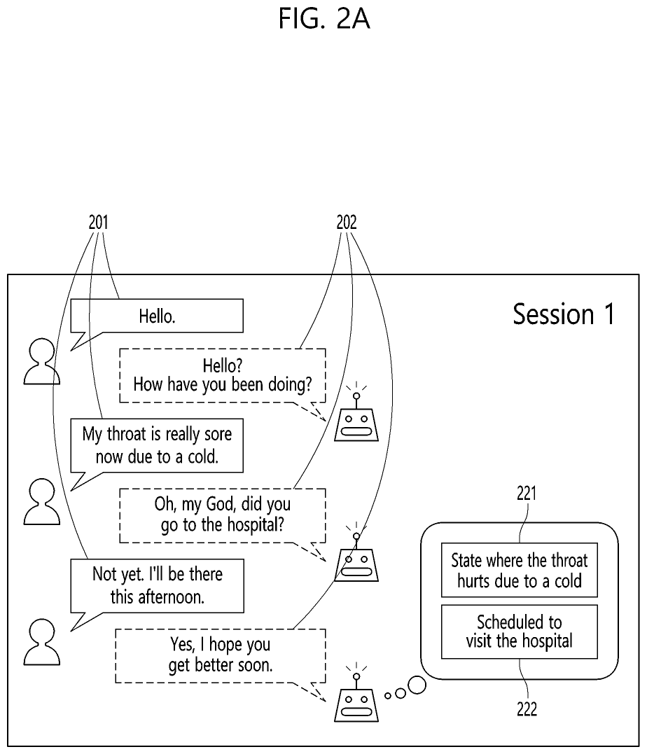

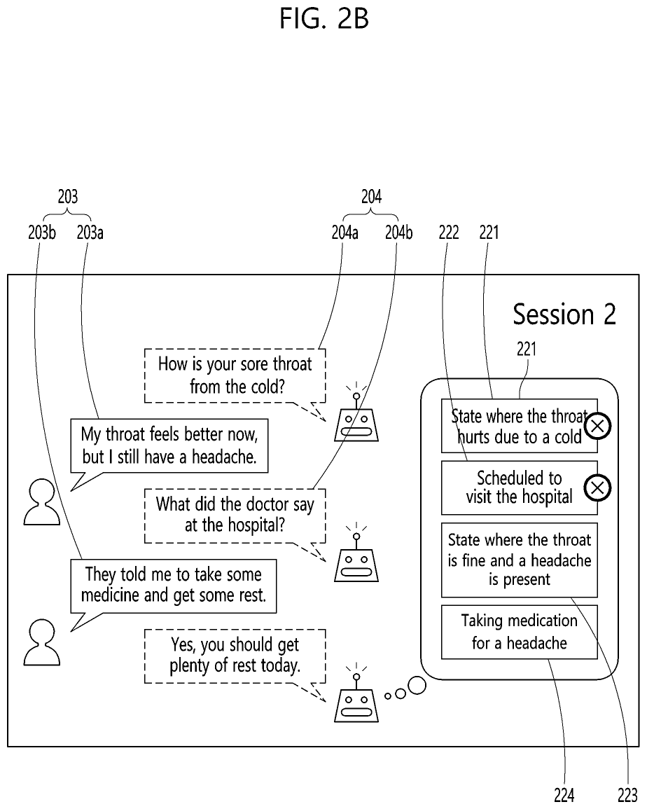

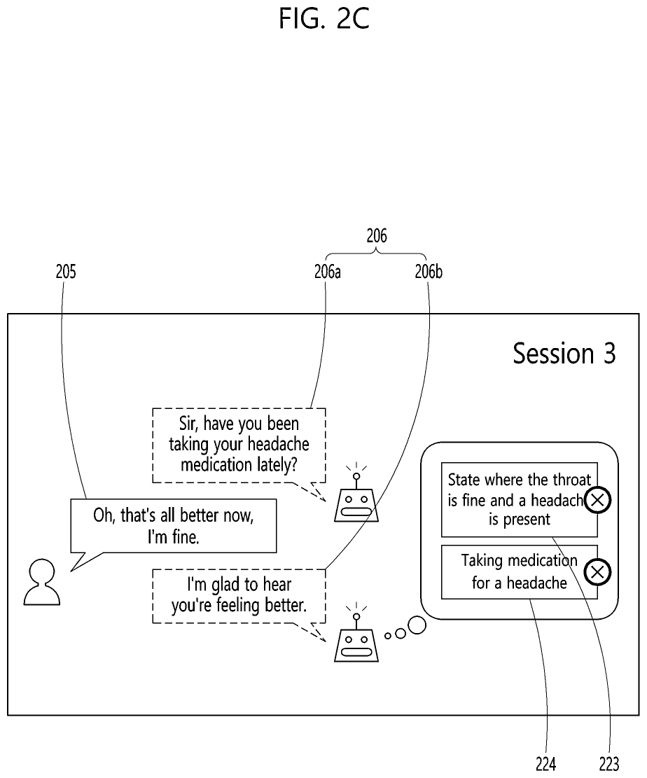

A conversation processing system 100 according to the present invention is based on memory management that may be used in the case where a series of multiple conversations occur between a user and an agent. As illustrated in FIGS. 2A, 2B, and 2C, when multiple conversation sessions (e.g., Session 1, Session 2, Session 3) are formed between the user and the agent, a method is provided that allows the current conversation session to be configured using conversation content from a previously formed conversation session. The conversation processing system 100 according to the present invention may perform a series of processes that receive a conversation between the user and the agent and store information on content of the conversation in a memory 130. In the present invention, information on existing conversation content stored in the memory 130 may be referred to as a “user's history.”

For example, assume that a first conversation session (e.g., Session 1, FIG. 2A), a second conversation session (e.g., Session 2, FIG. 2B), and a third conversation session (e.g., Session 3, FIG. 2C) are conversation sessions that occurred sequentially starting from the first conversation session.

When the second conversation session is in progress, user's histories 221 and 222 based on conversations 201 and 202 between the user and the agent in the previously conducted first conversation session (e.g., Session 1, FIG. 2A) may be used for an utterance 204 of the agent in the second conversation session. Further, when the conversation session corresponding to the third conversation session is in progress, user's histories 221, 222, 223, and 224 based on conversations 201, 202, 203, and 204 between the user and the agent that correspond to at least one of the first and second conversation sessions may be used for an utterance 206 of the agent in the third conversation session.

As illustrated, content related to at least part of the utterance 201 of the user in the first conversation session may be stored in the memory 130 as the user's histories 221 and 222. Further, the conversation processing system 100 may generate the utterance 204 of the agent in the second conversation session, which is formed between the user and the agent after the first conversation session, by using the user's history stored in memory 130.

When the first conversation session ends, the conversation processing system 100 may store content related to at least part of the conversation from the first conversation session in the memory 130 in the form of a sentence. Further, after the first conversation session, when the second conversation session is conducted between the user and the agent, the conversation processing system 100 may generate an utterance of the agent related thereto, using one of the sentences corresponding to the user's history.

For example, the agent may generate an utterance such as, “How is your sore throat from the cold?” 204a, which checks the user's state or situation regarding user's history “State where the throat hurts due to a cold” 221, remembered from a previous conversation session (or past conversation session).

For another example, in response to the user's history “Scheduled to visit the hospital” 222, the agent may generate an utterance 204b such as, “What did the doctor say at the hospital?” to check if the user has visited the hospital.

Similarly, when the second conversation session ends, the conversation processing system 100 may store information on at least part of the content of the conversation that was conducted in the second conversation session in the memory 130 as the user's histories 223 and 224. Further, the user's history stored in the memory 130 may be utilized in the third conversation session conducted after the second conversation session.

As described above, the conversation processing system 100 according to the present invention enables continuous monitoring and management of various states (e.g., health, sleep, etc.) or situations (e.g., housing situation, employment situation, etc.) of the user by managing and using the content of conversations conducted in multiple conversation sessions between the user and the agent in the memory, allowing for more natural and appropriate conversations with the user.

In the conversation processing system 100 according to the present invention, the memory 130 may be updated to ensure that the user's latest information is maintained for the same topic or category. That is, the user's history stored based on a past conversation session may be updated based on the conversation of a current conversation session.

For example, in the first conversation session, content (or sentence, (hereinafter, for convenience of description, the term “sentence” will be used, though it is not necessarily required to be in the form of a sentence)) such as “State where the throat hurts due to a cold” 221 is stored as a user's history. In this case, when it is analyzed from the conversation conducted in the second conversation session that the user's throat condition has improved, the sentence “State where the throat hurts due to a cold” 221 may be deleted, as the user is no longer in the state of having a sore throat, allowing the memory 130 to be updated.

As a similar example, content such as “Scheduled to visit the hospital” 222 is stored as a user's history. In this case, when it is analyzed from the conversation 203b conducted in the second conversation session that the user has visited a hospital, there is no longer a need to store the content “Scheduled to visit the hospital” 222 in the user's history, and thus, this sentence may be deleted.

As described above, the conversation processing system 100 according to the present invention may store memorable information related to the user from the conversation of the conversation session between the user and the agent as the user's history in the memory or delete unnecessary information. Further, in the next conversation session, by using the user's history to generate an utterance of the agent, a natural conversation based on the user's latest situation or state may be conducted.

To this end, the conversation processing system 100 according to the present invention may include a summarizer 110, a memory operator 120, the memory 130, and a generator 140. Further, the conversation processing system 100 may be configured to further include a retriever 150.

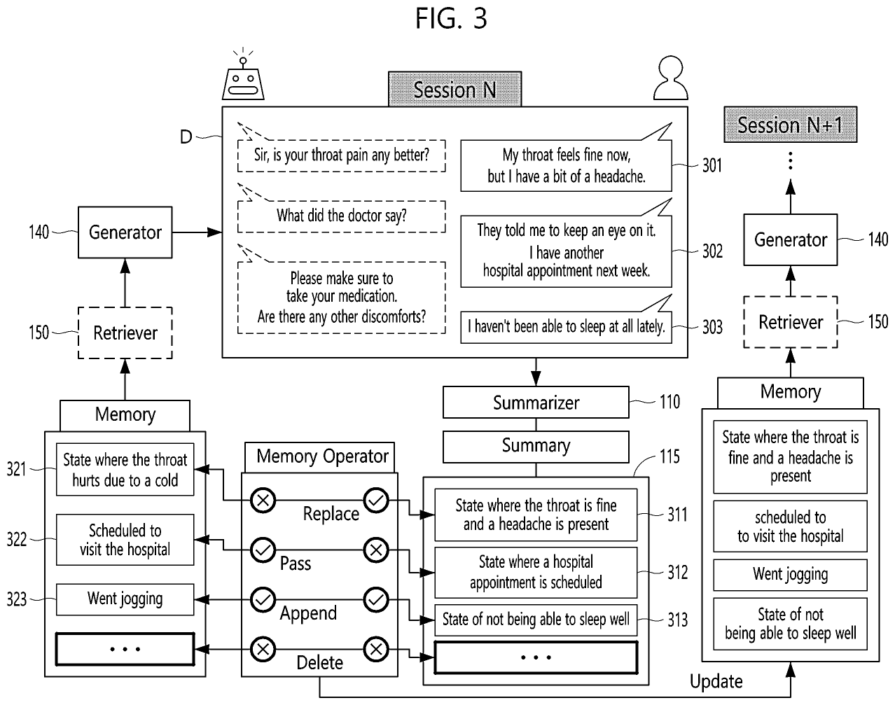

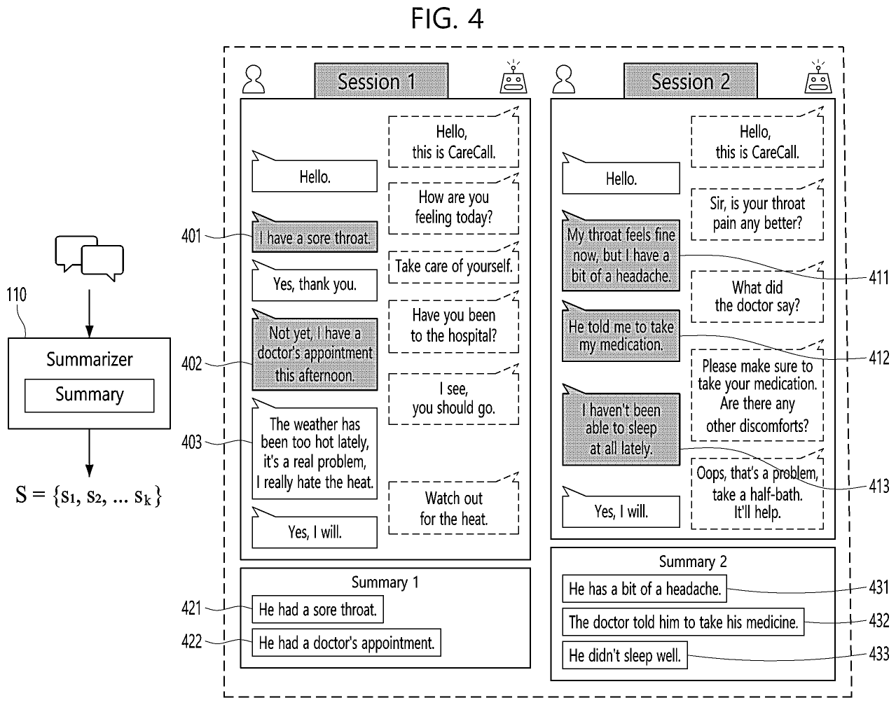

As illustrated in FIG. 3 and FIG. 4, the summarizer 110 may receive conversation content D of a conversation session conducted between the agent and the user and generate a summary 115. The conversation of an Nth conversation session may be delivered to the summarizer 110 for processing after the Nth conversation session has ended. An entity delivering a conversation to the summarizer 110 may be a service server providing a conversation service.

As illustrated, the conversation D, which includes both an utterance of the agent and an utterance of the user, is input to the summarizer 110, and the summarizer 110 may generate the summary 115 based on the conversation D.

More specifically, the summarizer 110 may summarize memorable information related to the user from the conversation content in the form of a natural language sentence.

The summarizer 110 may be configured as a language model trained to summarize memorable information related to the user from the conversation D in the form of a natural language sentence. For example, when a conversation is input, a pre-trained language model, which has already been trained on various types of information is allowed to generate summary content (e.g., a summary sentence (hereinafter, for convenience of description, the term “summary sentence” will be used, though it is not necessarily required to be in the form of a sentence)) using a language model that is tuned with a conversation session and a training data set consisting of key information memorable from the corresponding conversation session. Preferably, the language model may be trained to generate a summary sentence using a newline as a delimiter.

Specifically, a summary model, which summarizes memorable user information for a conversation record D into various natural language sentences S={S₁, S₂, . . . , Sₖ}, may train a parameter Φ to minimize the following loss with respect to a correct answer sentence (gold summary sentence Sₜ={W₁, W₂, . . . , W_{|St|}}).

$$L ϕ ( {S}_{t} , D , S < t ) = - \sum log p ϕ ( {W}_{i} \vert D , S < t , W < i )$$

The summarizer 110 may be trained to generate a summary sentence only for a preset category (or topic). For example, the preset category may be a category related to various states or situations of the user. As an example, the preset category may be related to health, sleep, exercise, meals, employment, and the like.

In this case, on the basis of the conversation content related to the health category within the conversation D, such as “My throat feels fine now, but I have a bit of a headache” 301, the summarizer 110 may generate summary information such as “State where the throat is fine and a headache is present” 311 or “State where the throat was sore but is now fine, and a headache is present.”

Further, based on the conversation content within the conversation D, such as “They told me to keep an eye on it. I have another hospital appointment next week” 302, the summarizer 110 may generate summary information such as “State where a hospital appointment is scheduled” 312.

Further, based on the conversation content within the conversation D related to the sleep category, such as “I haven't been able to sleep at all lately” 303, the summarizer 110 may generate summary information such as “State of not being able to sleep well” 313.

As a result of being trained to generate a summary sentence only for content corresponding to a preset category among the utterances of the user included in the conversation of the conversation session, the summarizer 110 may not generate a summary sentence for content that corresponds to a category different from the preset category among the utterance of the user. For example, as illustrated in FIG. 4, the summarizer 110 may generate summary sentences 421, 422, 431, 432, and 433 for the user utterances 401, 402, 411, 412, and 413 related to health, sleep, exercise, meals, or employment, which correspond to the preset category among the conversation of the conversation session (Session 1 or Session 2, etc.). Further, for a conversation 403 related to a category other than the preset category, for example, the “weather” category (“The weather has been too hot lately, it's a real problem, I really hate the heat”), the summarizer may not generate a summary sentence.

When a conversation is received, the summarizer 110 may use the summary model to generate summary sentences for the sentences corresponding to the user utterance and the agent utterance that configure the conversation with respect to the preset category. Specifically, the summary model may be a language model trained to receive the conversation and category information (e.g., “health,” “sleep,” etc.) as input and generate summary information related to the corresponding category from the conversation content. Therefore, the summary sentence summarized by the summarizer 110 may exist to be matched with information regarding which category the content of the corresponding summary sentence belongs to. In the memory 130 where the summary sentence is stored, the summary sentence may be stored and exist for each preset category. In the summarizer 110, before performing the summarization of the sentences, the categories of the sentences may first be classified, and as a result, the summarizer may generate summary sentences only for the sentences classified into the preset categories. Therefore, by not generating a summary sentence for sentences where summarization is unnecessary, data resources may be conserved.

Next, the memory operator 120 may control an operation of the memory 130 to ensure that the user's history (or user information) stored in the memory 130 maintains the most up-to-date information on the user.

The memory 130 may be positioned in at least one of the internal and external portions of the conversation processing system 100 (e.g., external server, cloud server, or cloud storage, etc.). As illustrated in FIG. 3, the memory operator 120 may use the summary sentence (or summary information, 311, 312, and 313) summarized by the summarizer 110 and the user's history pre-stored in the memory 130 (specifically, the sentences 321, 322, and 323 that configure the user's history) to specify operations for the memory 130.

As illustrated in FIG. 3, the user's history stored in the memory 130 may be configured according to the conversation content of previous conversation sessions formed between the user and the agent before the Nth conversation session is formed. The user's history stored in the memory 130 may be configured of summary sentences 321, 322, and 323, into which the summarizer 110 summarizes at least a portion of the conversations in previous conversation sessions. The user's history may include content related to the state or situation of the user.

The memory 130 may be updated according to the operation specified by the memory operator 120. The memory 130 may, according to the specified operation, i) store at least a portion of the summary information in the memory 130, or ii) delete at least a portion of the stored user's history.

The memory operator 120 may control the system to perform an operation corresponding one of different operations on the memory 130 for a pair of a summary sentence summarized from the conversation of the conversation session and a summary sentence included in the user's history stored in the memory 130. When an operation is performed on the summary sentence for the conversation of the Nth conversation session, the user's history stored in the memory 130 may be updated to reflect the content of the conversation of the Nth conversation session.

The different operations on the memory 130, as defined in the present invention, will be described with regard to a summary sentence (m) included in the user's history stored in the memory and a summary sentence(s) for the new conversation session.

A first operation may refer to an operation (PASS) in which the memory sentence m is kept stored in the memory 130, while the summary sentence s is not stored in the memory 130. The first operation may be a case in which the content of both sentences is identical or similar, or a case in which the content of the summary sentence s is included in the content of the memory sentence m. The first operation may be performed when there is no need to update the memory in this manner.

For example, as illustrated in FIG. 3, for the summary sentence “Scheduled to visit the hospital” 322, which corresponds to the user's history stored in the memory 130, and the summary sentence “State where a hospital appointment is scheduled” 312 from the current conversation session, the memory operator 120 may allow the user's history stored in the memory 130 to remain unchanged.

A second operation may refer to an operation (APPEND) in which the memory sentence m is kept stored in the memory 130, while the summary sentence s is also stored in the memory 130. The second operation may correspond a case in which the content of the memory sentence m and the content of the summary sentence s are either unrelated to each other or provide additional information.

For example, as illustrated in FIG. 3, since the summary sentence “Went jogging” 323, corresponding to the user's history stored in the memory 130, and the summary sentence of the current conversation session “State of not being able to sleep well” 313 are unrelated, the memory operator 120 may control the operation of the memory 130 so that the summary sentence “State of not being able to sleep well” 313 from the conversation session is newly added to the memory 130.

A third operation may refer to an operation (REPLACE) in which the memory sentence m is deleted from the memory 130, and the summary sentence s is stored in the memory 130. That is, the memory sentence m in the memory 130 may be replaced with the summary sentence s. The third operation may be a case in which the content of the two sentences does not match or is contradictory, and the memory operator 120 deletes the previously stored information in the memory 130 to maintain the user's history with the most up-to-date information on the user. For example, as illustrated in FIG. 3, for the summary sentence “State where the throat hurts due to a cold” 321, corresponding to the user's history stored in the memory 130, and the summary sentence “State where the throat is fine and a headache is present” 311 from the conversation session, in the content of conversation of the Nth conversation session, the user has transitioned to a state where the throat is no longer sore and a headache is present. Therefore, the memory operator 120 may control the operation of the memory 130 so that the summary sentence “State where the throat is fine and a headache is present” 311 is stored in the memory 130 in place of “State where the throat hurts due to a cold” 321.

A fourth operation may refer to an operation (DELETE) in which the memory sentence m is deleted from the memory 130, and the summary sentence s is also not stored in the memory 130. A case corresponding to the fourth operation may be when the content of the sentences no longer reflects the user's state or situation. For example, when the summary sentence “Took cold medicine” exists as part of the user's history, and the summary sentence “Recovered from a cold” is present in the Nth conversation session, the user has fully recovered from the cold, meaning cold medicine is no longer needed. In this case, the memory 130 no longer needs to retain information on the user related to the cold.

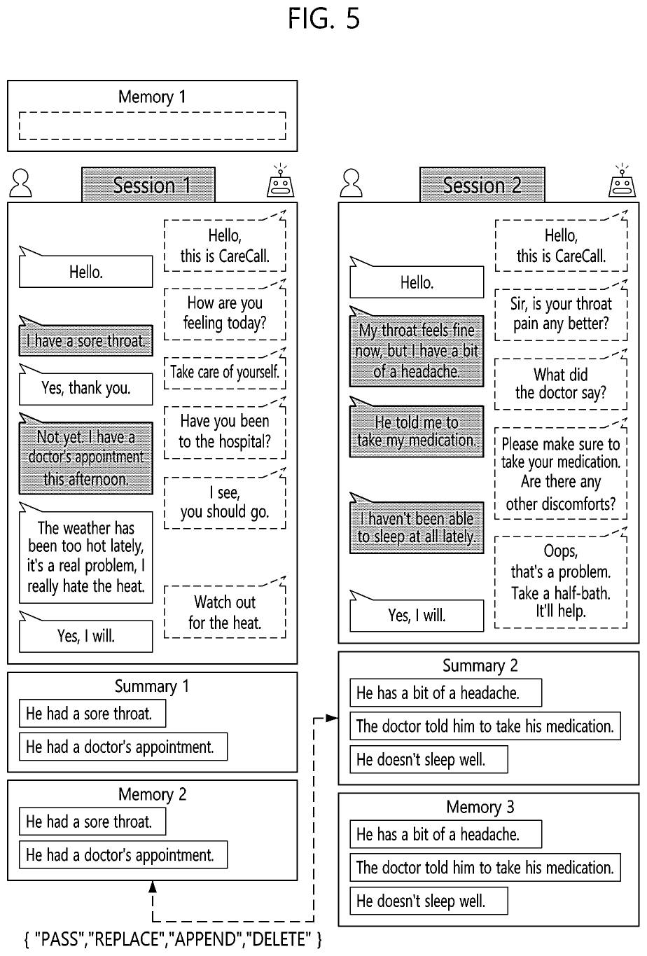

As illustrated in FIG. 5, the memory operator 120 may specify a memory operation in accordance with one of the first to fourth operations with respect to the summary sentences summarized from the conversation session and the user's history stored in the memory 130.

When the first conversation session (Session 1) is a first (very first or initial) conversation session related to the user, there may be no user's history in the memory (Memory 1). In this case, the operational result of the memory operator 120 for both the first conversation session (Session 1) and the user's history may be the second operation, “APPEND.” Therefore, in the memory (Memory 2), the summary sentences (Summary 1) summarized from the first conversation session (Session 1) may be stored as is.

After the first conversation session (Session 1), when the second conversation session (Session 2) takes place, the summarizer 110 may receive the conversation from the second conversation session and generate summary sentences (Summary 2) for the conversation of the second conversation session. Further, the memory operator 120 may update the memory 130 by using the user's history (Memory 2) stored in the memory 130 and the summary sentences (Summary 2) for the second conversation session. According to the specified operation of the memory 130 regarding the user's history (Memory 2) and the summary sentences (Summary 2) for the conversation according to the second conversation session, the user's history (Memory 3) reflecting the second conversation session (Session 2) may be configured.

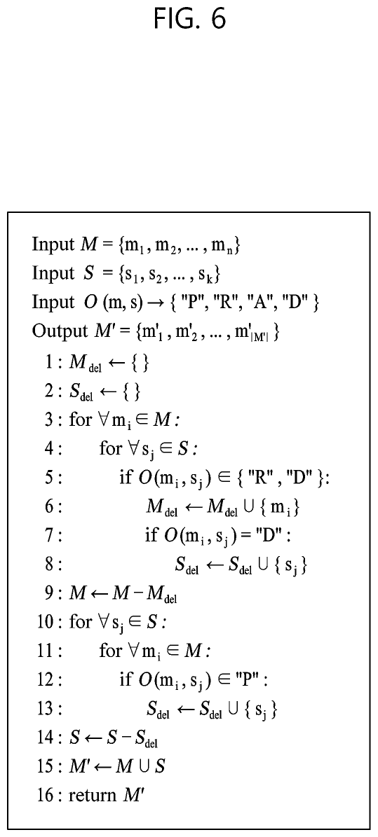

FIG. 6 briefly illustrates a memory update algorithm in the memory operator 120. The memory update process of the present invention may maintain the most up-to-date information on the user by combining existing information with new information using the previously described operations.

Given n stored memory sentences M={m₁, m₂, . . . , mₙ} in memory M and k new summary sentences S={S₁, S₂, . . . , Sₖ}, the memory operator 120 may use these to find a set of sentences M′={m′₁, m′₂, . . . , m′_{|M′|}} that is lossless, consistent, and free of duplication.

To find M′, a method of classifying the relationship of a pair of sentences (mᵢ, sⱼ) with mᵢ∈M, sⱼ∈S may be used. The memory operator 120 determines a value of one of {“PASS”, “REPLACE”, “APPEND”, “DELETE”}, corresponding to the first to fourth operations described above, for (mᵢ, Sⱼ).

A memory updater may update the memory to M′. According to an embodiment of the present invention, instead of comparing all pairs between the user's history and the summary sentence, the memory operation may be configured to be specified only for sentences corresponding to the same category.

In the memory 130, the summary sentences may be stored, classified by the category corresponding to each summary sentence. Therefore, the memory operator 120 may specify the operation of the memory 130 only for the summary sentences between categories that are the same.

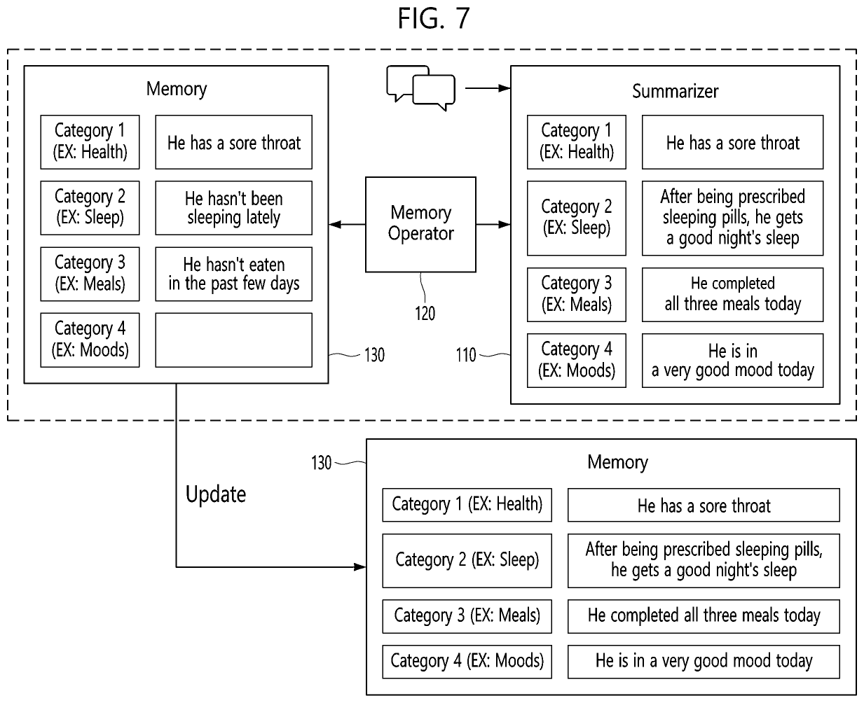

As illustrated in FIG. 7, when there are preset first to fourth categories, the memory operator 120 may compare sentences corresponding to each category as a pair. The memory operator 120 may specify any one of the previously mentioned first to fourth operations (PASS, APPEND, REPLACE, DELETE) for the sentences input as a pair for each category. As a result, the user's history stored in the memory 130 may be updated for each category.

In the memory 130, the summary sentence may exist as the user's history for each preset category. This is to ensure that only the most up-to-date information on the user's situation or state is maintained for each category.

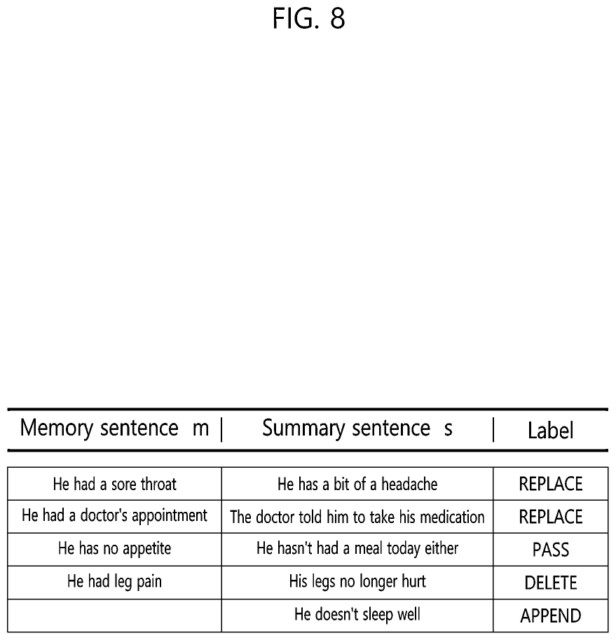

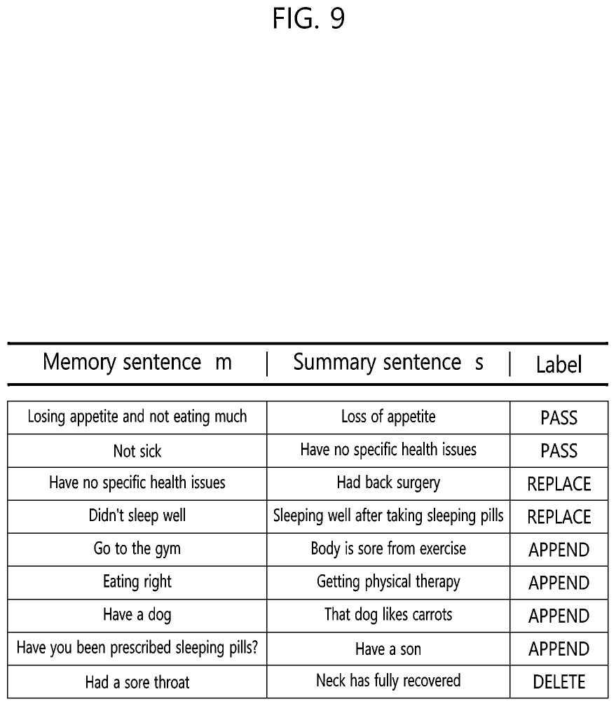

The memory operator 120, as described above, may be configured using a classification model trained to predict or specify the operation of the memory 130 corresponding to one of the first to fourth operations for a pair of sentences. The dataset for training the model may be configured of a pair of sentences, corresponding memory sentence m (or premise sentence) and summary sentence s (or hypothesis sentence), as illustrated in FIGS. 8 and 9, and a label indicating which of the first to fourth operations (PASS, APPEND, REPLACE, DELETE) the pair of sentences corresponds to.

The memory operator 120 may be trained based on a pair of sentences and a label of one of the first to fourth operations corresponding to the pair of sentences (e.g., mapped to a single token corresponding to each number from 0 to 3).

As a result of being trained using the method described above, the memory operator 120 may predict or specify the operation of the memory 130 corresponding to one of the first to fourth operations for a pair of sentences.

The generator 140 is configured to generate an utterance of the agent using the user's history stored in the memory 130.

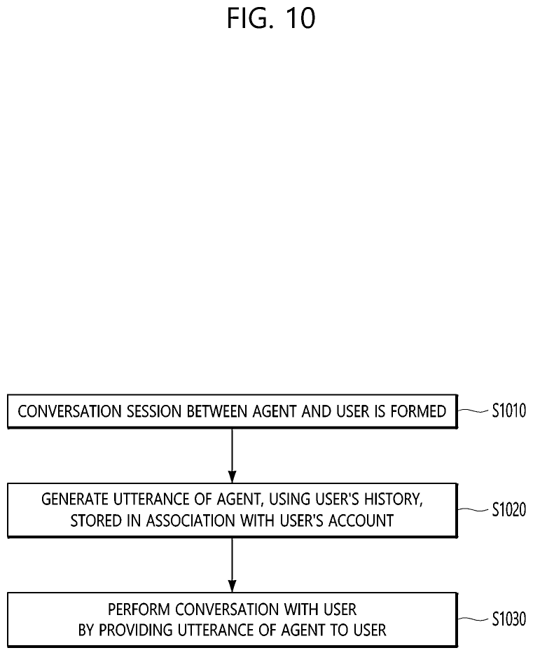

More specifically, as illustrated in FIG. 10, in the present invention, a process of forming a conversation session between the agent and the user (S1010) may proceed. Further, a process of generating an utterance of the agent using the user's history may proceed (S1020). As described in the previous explanation, the user's history may be configured based on information extracted from a previous conversation session that was formed between the agent and the user.

In the memory 130, a user's history corresponding to each user account may exist. The generator 140 may generate an utterance of the agent with reference to the user's history stored in association with to the user account of the user currently performing the conversation.

The generator 140 may generate an utterance of the agent by using at least a portion of the user's history stored in the memory 130 and a conversation history in the current session. A conversation history Dₜ at time step t may be represented as follows (c is an utterance of the agent, u is an utterance of the user).

Dₜ={c₁,u₁,c₂,u₂, . . . ,cₜ,uₜ}

Given at least a portion of the user's history and the conversation history Dₜ, the conditional probability of the next target response (i.e., the next utterance of the agent, cₜ₊₁), represented as cₜ₊₁={w₁, w₂, . . . , w_{|c}_{ₜ₊₁}}, may be expressed as the product of the conditional probability sequence as shown in Equation 1 below.

$$p ( {c}_{t + 1} \vert {D}_{t} , M ) = \prod {p}_{θ} ( {w}_{i} \vert {D}_{t} , M , w < i ) \qquad Equation 1$$

Here, wᵢ is a i-th token of the sequence, and θ represents a trainable parameter of the model. The generator 140 may be configured as a language model that is a pre-trained large language model trained on diverse information and fine-tuned using “maximum likelihood estimation (MLE).” This model is trained to minimize Equation 2.

$$L ϕ ( {S}_{t} , D , S < t ) = - \sum log p ϕ ( {W}_{i} \vert D , S < t , W < i ) \qquad Equation 2$$

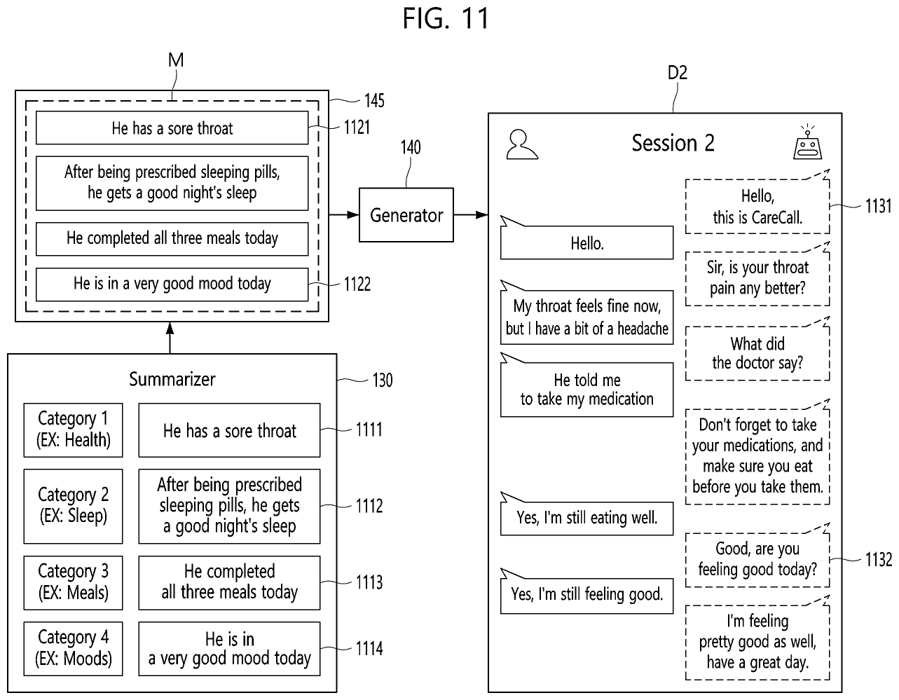

The generator 140 may generate an utterance of the agent using one of a plurality of summary sentences based on the context of the conversation in the ongoing conversation session, when there are the plurality of summary sentences each corresponding to a different plurality of categories related to the user's state or situation as the user's history (see reference numerals 1111, 1112, 1113, and 1114 of FIG. 11). As illustrated in FIG. 11, when a conversation session D2 between the user and the agent begins, all or some of the plurality of summary sentences 1111, 1112, 1113, and 1114 corresponding to the user's history stored in the memory 130 may be delivered to the generator 140 and used to generate the utterance of the agent in the ongoing conversation session.

The retriever 150 may select and deliver some of the plurality of summary sentences stored in the memory 130 to the generator 140. In some cases, the configuration of the retriever 150 may be omitted, and all of the plurality of summary sentences stored in the memory may be delivered to the generator 140.

The generator 140 may not use the plurality of summary sentences to generate the utterance of the agent when none of the plurality of summary sentences comprising the user's history correspond to the context of the conversation of the ongoing conversation session. That is, even if the user's history exists, the generator 140 may not use content that is irrelevant to the context of the conversation in the utterance of the agent. As described above, in the present invention, the process of performing a conversation with the user may proceed by providing the utterance of the agent, generated on the basis of the user's history, to the user (S1030).

As described above, according to the present invention, by storing the utterance of the user from a previous conversation session as the user's history and using the utterance of the user to perform a conversation with the user, it is possible to perform a natural conversation with the user on the basis of most up-to-date information according to the user's history. Furthermore, in the present invention, by performing a conversation with the user on the basis of the user's history, it is possible to monitor or check the user's situation or state according to the user's history.

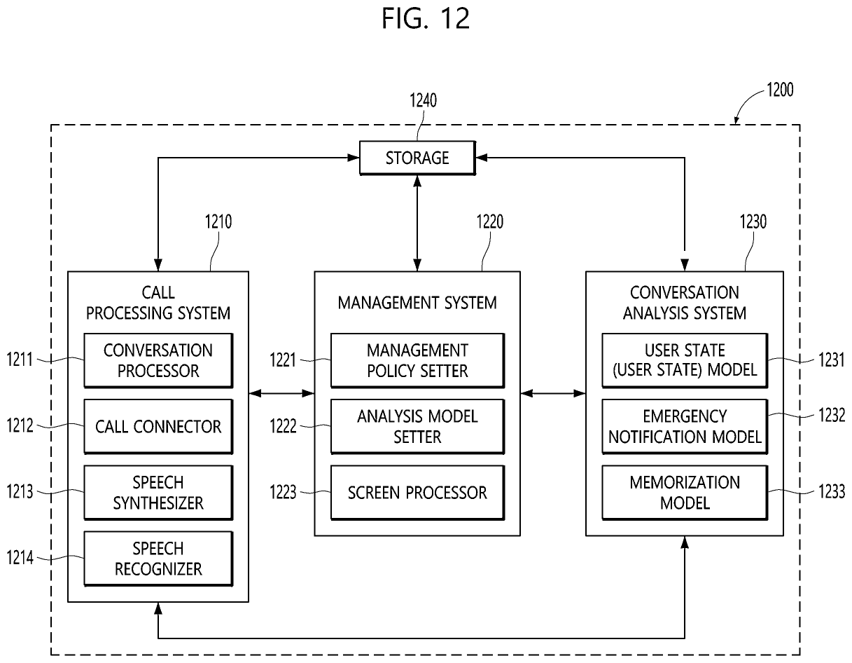

According to an embodiment of the present invention, a user monitoring method and a system may be provided to manage the user's state by periodically performing a conversation through call connections or the like with a specific user. With reference to FIG. 12, a user monitoring system 1200 according to the present invention may be configured to include at least one of a call processing system 1210, a management system 1220, a conversation analysis system 1230, or a storage 1240. Each configuration may be operated independently, and the functions exhibited by their combination may be expressed as being executed by the user monitoring method or the user monitoring system 1200.

The conversation analysis system 1230 may analyze the user's state or situation using an obtained conversation. The analyzed results may be provided to a human administrator through the management system 1220, allowing user monitoring to be performed.

The call processing system 1210 performs the role of initiating phone calls to users and conducting conversations with users through connected calls, initiate calls to users and obtain conversations according to a policy set by the management system 1220 (e.g., call management policy or call initiation policy).

The call processing system 1210 may be configured to include a conversation processor 1211, a call connector 1212, a speech synthesizer 1213, and a speech recognizer 1214.

The conversation processor 1211 provides a conversation function with the user to whom the call is connected. The conversation processor 1211 may perform a conversation with the user by generating an appropriate response to an utterance of the user on the basis of a language model trained on diverse information. In the present invention, various user utterances may be collected through an unstructured open conversation utilizing a language generation model, and these utterances may be analyzed to identify the user's state.

A specific method of generating a conversation in the conversation processor 1211 according to the present invention is as described above for the generator 140 of the conversation processing system 100. In this case, the other configurations of the conversation processing system 100 may correspond to the other configurations of the user monitoring system 1200 (e.g., storage 1240, memorization model 1233, etc.).

Further, the conversation processor 1211 may set the persona of the agent to give the user the feeling of having a conversation with a real person who sympathizes with and cares about the user's story. Further, the language model may be trained to generate utterances according to a scenario designed to correspond to the set persona. In addition, the conversation processor 1211 may be designed to enable attentive speaking techniques utilizing in the conversation or asking follow-up questions at an appropriate level of interest in response to the user's answers to express that the agent is listening to the user.

The call connector 1212 may be configured to initiate phone calls to users. The call connector 1212 may initiate calls to users on the basis of the call initiation policy. The call initiation policy may be set through the management system 1220.

The speech synthesizer 1213 may perform the role of converting the text generated by the conversation processor into speech so that the utterance of the agent may be output as speech. The speech synthesizer 1213 may express a natural voice using speech processing technologies (e.g., utilizing natural end-to-end speech synthesis (NES) and high-quality DNN text-to-speech (HDTs) technologies in a hybrid manner). The speech synthesizer 1213 may train a voice of an agent according to various call situations. For example, the speech synthesizer 1213 may be trained to use a bright and lively voice as a default voice, or to utter with a voice that sympathizes with and shows concern for the user's situation, depending on the situations.

The speech recognizer 1214 may be configured to recognize and convert the user's speech utterance into text. For example, the speech recognizer 1214 may use a speech recognition technology that utilizes an advanced large language model trained on diverse and large-scale data. Furthermore, the model may be trained to exhibit excellent performance for users' age-related characteristics and user's characteristics in consideration of geographical regions.

The speech recognizer 1214 may recognize the user's speech using one of the speech recognition models specialized for different characteristics (e.g., characteristics defined by criteria such as geographical regions or age group). For example, the speech recognizer 1214 may better recognize the user's speech using one of the various speech recognition models specialized for dialects of a specific region, particular pronunciations by elderly users, or the like. Which model to use among the plurality of models may be specified on the basis of the administrator's selection in the management system 1220 or a user to whom the call is made.

The conversation obtained from the call processing system 1210 may be delivered to at least one of the management system 1220, the conversation analysis system 1230, or the storage 1240.

The management system 1220 may set a policy for a call to be initiated to the user and provide information on the current status of the call that has been initiated to the user or the user's state. The management system 1220 may obtain information on items to be checked to identify the user's state (e.g., health, sleep, meals, exercise, outings, etc.) and provide the obtained information to the administrator. The management system 1220 may receive and provide the analyzed information from the conversation analysis system 1230 to the administrator, and provide a notification to the administrator or a guardian when any unusual matter requiring checking or monitoring (e.g., health anomaly signals) is detected. For example, the management system 1220 may provide the functions of monitoring users who require management based on the conversation between the user and the agent, identifying abnormal or emergency situations, and quickly taking action (e.g., confirming that a senior person is waiting for emergency services and making additional contact, or verifying that a meal delivery was missed and taking related action).

The management system 1220 may include a management policy setter 1221, an analysis model setter 1222, and a screen processor 1223.

The management policy setter 1221 may manage a policy (or “call initiation policy”) for calls initiated to the user. The management policy setter 1221 may set a policy for at least one aspect, such as a user who is a target of call initiation, a call initiation time, and an initiation period. In the present invention, the policy refers to an execution unit of call initiation, where a single policy may include one or more users (recipients), initiation settings (e.g., initiation time, initiation frequency, initiation period, etc.), reporting subjects, and the like. Additionally, one or more groups (e.g., call initiation group by day of the week) may be configured to be added to one policy, allowing the users to be divided and managed accordingly.

The management policy setter 1221 may set multiple policies, and in each policy, at least one user may be specified to have the corresponding policy applied to the user. The policy may be set based on the administrator's selection according to various criteria (e.g., a specific geographic range). For example, a policy may be set based on “Magok-dong, Gangseo-gu, Seoul,” and the users residing in this area may be set to have the policy applied to them. In addition, in a specific policy, there may be multiple groups further divided based on this criterion (e.g., in a policy based on “Gangseo-gu,” there may be groups such as a “Magok-dong” group and a “Balsan-dong” group, divided based on multiple regions included in Gangseo-gu).

The analysis model setter 1222 may perform the role of setting an analysis model for analyzing a conversation obtained from the call processing system 1210. Once the analysis model is set by the analysis model setter 1222, information of the set analysis model may be delivered to the conversation analysis system 1230. The conversation analysis system 1230 may use the analysis model according to the received information to analyze the conversation and deliver the analysis results to the management system 1220.

The screen processor 1223 may provide various information related to calls and users on the basis of the information received from the call processing system 1210 and the conversation analysis system 1230. For example, the screen processor 1223 may visually provide current situation information or statistical information on the initiated calls (e.g., total number of initiated calls, number of completed calls, number of answered calls, number of missed calls, etc.) as well as state information on the users. In addition, the user's history generated by the memorization model 1233 may be provided.

Further, on a management page, settings based on the administrator's selection, such as the policy setting, group setting, and analysis model setting, as described above, may be enabled.

The conversation analysis system 1230 may include various types of functions for analyzing conversations, such as a user state model 1231, an emergency notification model 1232, and the memorization model 1233. The conversation analysis system 1230 may input the conversation into each model to obtain the conversation analysis results. When a conversation session between the user and the agent is terminated, the call processing system 1210 may deliver the conversation obtained from the terminated conversation session to the conversation analysis system 1230, where the conversation may be analyzed.

The user state model 1231 may analyze (determine or detect) the user's state from the content of the conversation. The user state model 1231 may be configured of a classification model trained to determine the user's state for specific categories. For example, the user state model 1231 is trained to classify the user's state as positive, negative, or unknown (or irrelevant) for each category, such as health, meals, sleep, exercise, or time outside home. The categories that are subject to state determination (or classification) may be set based on the administrator's selection in the management system 1220.

The emergency notification model 1232 is configured to identify the user's emergency situation (or abnormal situation) from the conversation. The emergency notification model 1232 may be designed to extract key abnormal signals, such as emergency situations that require the administrator's monitoring. For example, the emergency notification model 1232 may be implemented using a deep learning model trained to classify predefined emergency situations (e.g., health-related risk utterances) or by a method of extracting summary information (or summary sentences) about the utterances of the user through slot processing. The information regarding the emergency situation determined by the emergency notification model 1232 may be delivered to the management system 1220 and provided to the administrator.

The memorization model 1233 ensures that memorable information regarding the user from the conversation between the user and the agent is stored as the user's history. The user's history may be used when the utterance of the agent is generated in the call processing system 1210. Therefore, the agent may reduce the repetition of the same questions in each conversation session with the user and proceed with the conversation based on the user's information, thereby enhancing the sense of familiarity with the user. The memorization model 1233 may update the user's history on the basis of the latest conversation session between the user and the agent, ensuring that the user's most up-to-date information is maintained for the same topic or category.

As a specific embodiment of the memorization model 1233, a method of using the user's history to generate conversations in the aforementioned conversation processing system 100 may be used.

The present invention described above, including the generator 140, the memory operator 120 and the summarizer 110 of the system 100, and the call processing system 1210, the management system 1220 and the conversation analysis system 1230 of the system 1200, may be executed by one or more processes on a computer and implemented as a program that can be stored on a computer-readable medium (or recording medium).

Further, the present invention described above may be implemented as computer-readable code or instructions on a medium in which a program is recorded. That is, the present invention may be provided in the form of a program.

The computer-readable medium includes all kinds of storage devices for storing data readable by a computer system. Examples of computer-readable media include hard disk drives (HDDs), solid state disks (SSDs), silicon disk drives (SDDs), ROMs, RAMs, CD-ROMs, magnetic tapes, floppy discs, and optical data storage devices.

Further, the computer-readable medium may be a server or cloud storage that includes storage and that the electronic device is accessible through communication. In this case, the computer may download the program according to the present invention from the server or cloud storage, through wired or wireless communication.

Further, in the present invention, the computer described above is an electronic device equipped with a processor, that is, a central processing unit (CPU), and is not particularly limited to any type.

It should be appreciated that the detailed description is interpreted as being illustrative in every sense, not restrictive. The scope of the present invention should be determined based on the reasonable interpretation of the appended claims, and all of the modifications within the equivalent scope of the present invention belong to the scope of the present invention.

1. The conversation provision method, comprising:
forming a conversation session between an agent and a user;
generating an utterance of the agent using the user's history related to a previous conversation session having been formed prior to the conversation session; and
performing a conversation with the user by providing the utterance of the agent to the user.

2. The conversation provision method according to claim 1, wherein the user's history is configured of summary content summarizing the utterance of the user from the previous conversation session formed between the agent and the user prior to the conversation session, and the summary content includes content related to the user's state or situation.

3. The conversation provision method of claim 2, wherein, when a plurality of summary content corresponding each to a plurality of different categories related to the user's state or situation exist in the user's history, in the generating of the utterance of the agent, the utterance of the agent is generated using one summary content of the plurality of summary content that corresponds to context of the conversation of the conversation session, on the basis of the context of the conversation in the conversation session.

4. The conversation provision method of claim 1, wherein summary content exists in the user's history for each of a plurality of different categories.

5. The conversation provision method of claim 1, further comprising:
delivering, when the conversation session ends, the conversation of the conversation session to a summarizer; and
summarizing, in the summarizer, a specific utterance of the utterance of the user included in the conversation of the conversation session and corresponding to a preset category in the form of a sentence.

6. The conversation provision method of claim 5, wherein the summarizer is trained to generate summary content only for content of the utterance of the user included in the conversation of the conversation session that corresponds to the preset category.

7. The conversation provision method of claim 6, further comprising:
obtaining an output value corresponding to a specific operation corresponding to one of different operations for a memory, with respect to a pair of summary content summarized from the conversation of the conversation session and summary content included in the user's history stored in the memory; and
updating the user's history stored in the memory according to the output value.

8. The conversation provision method of claim 7, wherein a first operation of the different operations is an operation that maintains the storage of the summary content corresponding to the user's history from the pair of summary content in the memory, but does not store the summary content summarized from the conversation of the conversation session in the memory,
a second operation of the different operations is an operation that maintains the storage of the summary content corresponding to the user's history from the pair of summary content from the memory, while also storing the summary content summarized from the conversation of the conversation session in the memory,
a third operation of the different operations is an operation that deletes the summary content corresponding to the user's history from the pair of summary content from the memory and stores the summary content summarized from the conversation of the conversation session in the memory, and
a fourth operation of the different operations is an operation that deletes the summary content corresponding to the user's history from the pair of summary content from the memory and does not also store the summary content summarized from the conversation of the conversation session in the memory.

9. A conversation processing system, comprising:
a memory configured to store a user's history related to a past conversation session;
a summarizer configured to receive a conversation of a current conversation session formed between an agent and a user, and to summarize at least part of an utterance of the user included in the conversation in the form of a sentence; and
a memory operator configured to specify an operation for the memory using summary information summarized by the summarizer and the user's history.

10. The conversation processing system of claim 9, wherein the summary information and the user's history include content summarized by the summarizer, and
wherein the memory operator specifies an operation for the memory using a pair of specific content included in the summary information and specific content included in the user's history.

11. The conversation processing system of claim 10, wherein the pair of content are content corresponding to a same category.

12. The conversation processing system of claim 11, wherein the memory is updated so that the user's history reflects the conversation of the current conversation session on the basis of the operation for the memory.

13. The conversation processing system of claim 12, further comprising:
a generator configured to generate an utterance of the agent,
wherein the generator generates the utterance of the agent in a newly formed conversation session between the agent and the user, after the current conversation session ends, using the updated user's history.

14. A computer-readable recording medium storing a program, which when executed by one or more processes in an electronic device, causing the electronic device to execute the steps comprising:
forming a conversation session between an agent and a user;
generating an utterance of the agent using a user's history related to a previous conversation session formed prior to the conversation session; and
performing a conversation with the user by providing the utterance of the agent to the user.
